(19) United States
(12) Patent Application Publication
(10) Pub. No.: US 2016/0034493 A1
(43) Pub. Date: Feb. 4, 2016

(54) Systems and Methods for the Collection Verification and Maintenance of Point of Interest Information

(71) Applicant: Google Inc., Mountain View, CA (US)

(72) Inventors: Alexander Thomas Starns, Menlo Park, CA (US); Qiushuang Zhang, Beijing (CN); Kun Shing Luk, Kowloon (HK); Arjun Raman, Union City, CA (US); Nishant Nair, Andhra Pradesh (IN); Xin Li, San Jose, CA (US)

(21) Appl. No.: 14/449,504

(22) Filed: Aug. 1, 2014

(51) Int. Cl. G06F 17/30

(52) U.S. Cl. CPC G06F 17/30241; G06F 17/30303

(57) ABSTRACT

Systems and methods for the collection, verification, and maintenance of point of interest information are provided. One example system includes a plurality of mobile collection devices respectively operated by a plurality of human collectors. Each of the mobile collection devices uploads to one or more intermediate servers information describing one or more attributes of a plurality of points of interest. The system includes a mobile verification device that receives, from the one or more intermediate servers, information uploaded by a first mobile collection device and provides an indication of an accuracy associated with the information received from the first mobile collection device. The system includes the one or more intermediate servers. The system includes one or more production servers. The information uploaded by the first mobile collection device is transcribed from the one or more intermediate servers to the one or more production servers.

### FIELD

The present disclosure relates generally the collection of point of interest information. In particular, the present disclosure relates to systems and methods for the collection, verification, and maintenance of points of interest information, such as business listings.

### BACKGROUND

Information concerning points of interest is increasingly being used in a variety of platforms, including by a variety of applications and services that are available over computer networks such as the Internet. Information about points of interest can include a name, address, phone, category, location, website, business hours, email or other information about the point of interest.

A variety of web services such as mapping services, directory services, search engines, online advertising services, review platforms, government services, and other business services are accessing or otherwise using point of interest information as part of their service.

Challenges with maintaining and updating point of interest information arise in many situations. In some cases, information can have errors in its original collection that need to be corrected. In other cases, potentially accurate data needs to be verified, or data that was accurate has changed and needs to be modified.

For example, point of interest information often needs to be updated in accordance with changes in a business area or conditions, such as when a business closes or new businesses open, or when building zoning or development changes impact a street or neighborhood. These challenges to updating point of interest information are especially difficult given that changes in a business area or situation are not likely to be automatically detected by any currently existing system.

### SUMMARY

Aspects and advantages of the present disclosure will be set forth in part in the following description, or may be apparent from the description, or may be learned through practice of embodiments of the present disclosure.

One example aspect of the present disclosure is directed to a computer-implemented method for information collection and verification. The method includes receiving, by one or more computing devices from each of a plurality of mobile collection devices, a plurality of information uploads respectively describing one or more attributes for a plurality of points of interest. The plurality of mobile collection devices are respectively operated by a plurality of human collectors. The method includes providing, by the one or more computing devices to a mobile verification device, the plurality of information uploads associated with a first human collector of the plurality of human collectors. The mobile verification device is operated by a human verifier. The method includes receiving, by the one or more computing devices from the mobile verification device, data indicative of an accuracy associated with one or more of the plurality of information uploads associated with the first human collector. The method includes determining, by the one or more computing devices or the mobile verification device, a score for the first human collector based at least in part on the data indicative of the accuracy associated with the one or more of the plurality of information uploads associated with the first human collector. The score determined for the first human collector is used at least in part to determine whether to approve the plurality of information uploads associated with the first human collector.

Another example aspect of the present disclosure is directed to one or more non-transitory computer-readable media storing instructions that, when executed by one or more computing devices, cause the one or more computing devices to perform operations. The operations include receiving, from a mobile collection device operated by a human collector, data describing one or more attributes for each of a plurality of points of interest. The operations include providing, to a mobile verification device operated by a human verifier, the data describing the one or more attributes for each of the plurality of points of interest. The operations include receiving, from the mobile verification device, an indication of an accuracy associated with the one or more attributes for one or more of the plurality of points of interest. It is determined whether the data received from the mobile collection device describing the one or more attributes for each of the plurality of points of interest should be approved based at least in part on the indication of the accuracy received from the mobile verification device. The operations include, when the data received from the mobile collection device is approved, providing, to a transcription device, the data describing the one or more attributes for each of the plurality of points of interest. The operations include receiving, from the transcription device, updated data describing the one or more attributes for each of the plurality of points of interest. The updated data includes one or more edits.

Another example aspect of the present disclosure is directed to a system for collecting information. The system includes a plurality of mobile collection devices respectively operated by a plurality of human collectors. Each of the mobile collection devices uploads to one or more intermediate servers information describing one or more attributes of a plurality of points of interest. The system includes a mobile verification device. The mobile verification device receives, from the one or more intermediate servers, information uploaded by a first mobile collection device of the plurality of mobile collection devices and provides an indication of an accuracy associated with the information received from the first mobile collection device. A score is calculated for the human collector of the first mobile collection device based at least in part on the indication of the accuracy provided by the mobile verification device. The score is used to assist in a determination of whether to approve the information uploaded by the first mobile collection device for transcription. The system includes the one or more intermediate servers. The system includes one or more production servers. The information uploaded by the first mobile collection device is transcribed from the one or more intermediate servers to the one or more production servers when the information is approved for transcription.

These and other features, aspects, and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling description of the present disclosure, directed to one of ordinary skill in the art, is set forth in the specification, which makes reference to the appended figures, in which:

FIG. 1 depicts an example system according to an example embodiment of the present disclosure;

FIGS. 2A-2C depict example mobile collection device user interfaces according to an example embodiment of the present disclosure;

FIG. 3 depict an example route planning user interface according to an example embodiment of the present disclosure;

FIG. 4 depicts an example mobile collection device user interface according to an example embodiment of the present disclosure;

FIGS. 5A-5D depict example mobile verification device user interfaces according to an example embodiment of the present disclosure;

FIG. 6 depicts an example transcription device user interface according to an example embodiment of the present disclosure; and

FIGS. 7A-7E depict example mobile maintenance device user interfaces according to an example embodiment of the present disclosure.

### DETAILED DESCRIPTION

### Overview

The present disclosure is directed to systems and methods for the collection, verification, and maintenance of point of interest information, such as business listings. In particular, the systems and methods of the present disclosure provide a novel pipeline and tools for managing work control and data flow in the context of the collection and processing of street-level geographic information (e.g. for inclusion in a geographic information system).

As an example, a system can include a plurality of mobile collection devices respectively operated by a plurality of human collectors as they travel about in the world. The human collectors can use the mobile collection devices to upload information describing one or more attributes of a plurality of points of interest (e.g. business name, location, category, telephone, website, business hours, etc.).

As an example, an area (e.g. a city) for which the collection of point of interest information is desired can be divided into a plurality of regions. The plurality of regions can be respectively assigned to the plurality of human collectors. The human collectors can travel through their assigned region collecting information about points of interest. The collected information can be manually entered into the mobile collection device by the human collector. Additionally or alternatively, the human collector can use the mobile collection device to obtain photographs or other images depicting certain information associated with the point of interest. The collected information can be uploaded to a central processing center.

In some embodiments, in addition to an indication of its assigned region, each mobile collection device can be provided with a routing that provides a path for the human collector operating such mobile collection device to traverse through the geographic region. In particular, the path provided by the routing can minimize the distance traveled by the human collector while maximizing the likelihood of the human collector discovering a large number of relevant points of interest.

According to an aspect of the present disclosure, the uploaded information can be subjected to a quality control process. In particular, the information uploaded by a particular human collector via a mobile collection device can be provided to a mobile verification device operated by a human verifier. The human verifier can visit the reported points of interest and provide an indication of an accuracy of the information collected by the particular human collector.

In some embodiments, the human verifier can indicate the accuracy of the information collected on an attribute-by-attribute basis. For example, each attribute can be indicated as being incorrect, missing, or unverifiable. In some embodiments, incorrect attributes can be indicated as including either a major error or a minor error. Furthermore, the human verifier can indicate that the particular human collector missed or otherwise failed to provide information concerning one or more points of interest located within the region that was assigned to the particular human collector. The verification tool may also allow for identification of fake listings. For example, the original human collector may have created fake (e.g. non-existent) listings to improve their productivity numbers. The verification tool can allow the human verifier to identify these non-real locations and mark them as such. In such fashion, the human verifier can audit the information received from the particular human collector.

A score can be determined for the particular human collector based at least in part on the indications of accuracy provided by human verifier. For example, the score can be determined using a scoring formula or scoring matrix. As an example, the human collector can receive points for correctly reported attributes and lose points for incorrect or missing attributes. Major errors can result in larger reduction in points than minor errors. In some embodiments, the score can be calculated by the mobile verification device at the end of a verification session. Alternatively, the score can be calculated by a central authority after receiving the data from the mobile verification device.

The score can be used to determine whether to approve the information uploaded by the particular human collector or to deny such information and send for re-collection. In some embodiments, the approval or disapproval of each human collector can be automated or otherwise be implemented according to certain logic or an algorithm. For example, if the current or average score determined for a given human collector exceeds a threshold value, then the information provided by such human collector within a recent time period (e.g. day or week) can be automatically approved.

In other embodiments, a moderator or administrative user can view the scores for various human collectors and provide user input indicating whether the information uploaded by each human collector should be approved or denied. For example, an administrative user can operate a dashboard device to administratively interact with the system (e.g. receive statistics and/or provide work flow commands). The administrative user can determine whether to approve or deny information received from each human collector based on such collector's score.

Once information is approved, the uploaded information can be provided to a transcription device through which a transcriber transcribes the information. Transcribers may include human transcribers, automated transcribers, or any combination thereof. As an example, the human transcriber can inspect and clean up the collected information. For example, typographic errors can be eliminated, shorthand entries can be formalized, and/or duplicate entries can be identified and resolved by the human transcriber. In another example, a human transcriber may review processing performed by an automated transcriber.

In some embodiments, the information uploaded by the human collectors can be photographs or other images that depict the attributes of the point of interest. For example, it may be easier for the human collector to capture (e.g. with the mobile collection device) an image of the storefront of a point of interest that displays hours of operation than to physically enter the hours of operation into a text data field. Thus, in such embodiments, the transcriber can transcribe the textual information contained in the photographs into particular text entry fields corresponding to certain attributes of the point of interest.

In particular, in some embodiments of the present disclosure, one or more optical character recognition techniques can be applied to each image to extract the textual information contained within such image. The extracted textual information can be available for selection (e.g. within a user interface provided by the transcription device). For example, the human or automated transcriber can copy and paste or drag-and-drop the extracted textual information into the particular text entry fields corresponding to certain attributes of the point of interest. In some embodiments, the character recognition techniques can allow for automatic processing (e.g. transcription) of the textual information included in the images. For example, certain keywords may be used or recognized to automatically extract and associate textual information with one or more particular attributes of the corresponding point of interest listing. Thus, for example, the text “M-F 8-5” can be recognized as communicating information associated with a business hours attribute and can be automatically provided for such attribute without needing to be indicated or transcribed as such by the human transcriber.

The transcription stage may also have a quality control process. For example, data describing one or more edits performed by the transcriber can be provided to a transcription verification device. A human operator of the transcription verification device can indicate an accuracy associated with one or more of the edits and the one or more edits can be approved or denied based at least in part on the indication of accuracy. In some implementations, the transcription verification device may be a fully or partially automated system.

After transcription, the information can be published for use by various web services, such as, for example, a search engine, a mapping application or other geographic information system, or other online tools. For example, the information can be published into a production server that stores and provides point of interest information to the web services.

The systems of the present disclosure can further include one or more maintenance devices operated by human maintenance operators. In particular, information describing certain points of interest can be selected for re-verification or maintenance and a listing of such selected points of interest can be provided to a maintenance device. For example, the selection of certain points of interest for re-verification can be based at least in part on one or more of an age associated with the information associated with each point of interest, a number of user-reported errors, and a value of the location associated with each point of interest. In some embodiments, the maintenance operations may be fully or partially automated.

The human maintenance operator can physically visit the selected points of interest and provide an indication of whether the information describing each of such points of interest is verifiable, unverifiable, incorrect, or no longer available. For example, certain business listings can be indicated as closed. New listings may also be provided via the maintenance device. In such fashion, previously collected point of interest information can be re-verified over time.

Thus, the systems and methods of the present disclosure provide a novel, highly-scalable pipeline and associated software tools for the collection, processing, and maintenance of point of interest information. The system provides tools for managing work control and data flow and includes multiple instances of quality control. Furthermore, features such as optimized routing for street-level data collection and optical character recognition for transcription of textual information from collected images enhance the speed and efficiency of data collection and processing.

### Example System

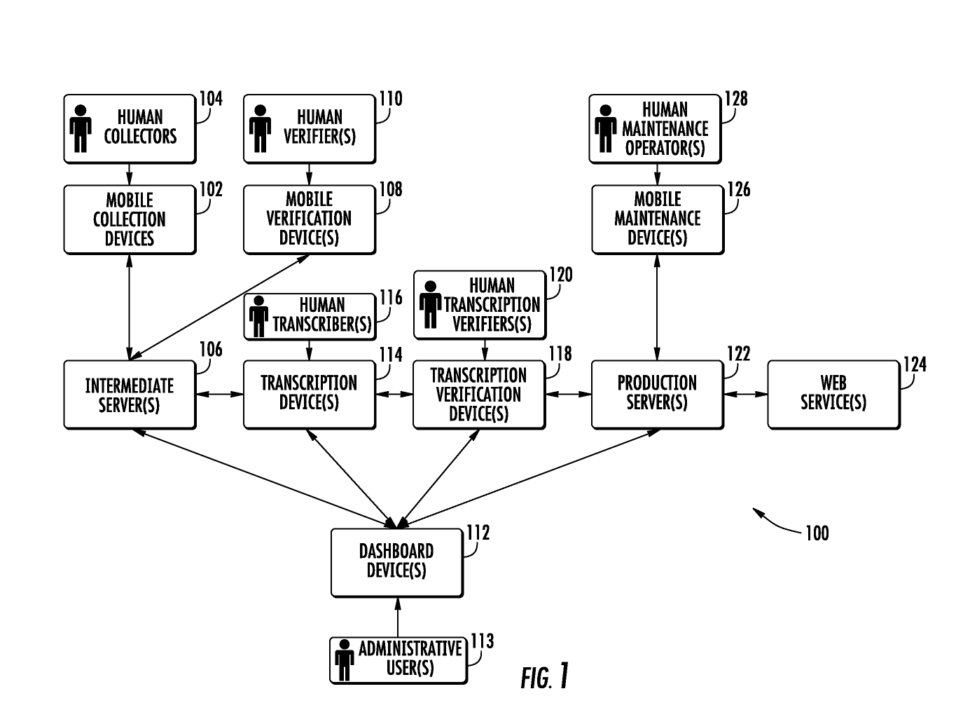

FIG. 1 depicts an example system 100 according to an example embodiment of the present disclosure. Example system 100 can include a plurality of mobile collection devices 102. The mobile collection devices 102 can be respectively operated by a plurality of human collectors 104. The human collectors 104 can operate the mobile collection devices 102 as they move about in the world. In particular, the human collectors 104 can enter observed information concerning points of interest into a mobile collection device 102. The mobile collection device 102 can upload the information to one or more intermediate servers 106.

Each mobile collection device 102 can be a computing device that is capable of being transported by a human collector 104 as the human collector 104 travels about in the world. For example, mobile collection device 102 can be a mobile computing device such as, for example, a smartphone, tablet, netbook, computing-enabled eyeglasses, computing-enabled watch, wearable computing device, or other portable computing devices. In other embodiments, the mobile collection devices 102 may be partially or fully automated (e.g. by automatically capturing and uploading photographs of points of interest as it moves about in the world).

Each mobile collection device 102 can include various modules or software programs that the device 102 implements to perform desired operations. For example, each mobile computing device 102 can include one or more processors that implement instructions stored in a memory of the device 102 to perform operations and respond to user input.

In an example implementation of system 100, the human collector 104 of each mobile collection device 102 can be assigned (e.g. by a central authority and/or self-assignment) to collect point of interest information available in a particular region (e.g. portion of a city). Alternatively, each human collector 104 can be assigned listing of certain points of interest or a combination of a listing of points of interest and an assigned region.

In particular, various factors can influence the selection of regions or points of interest for a human collector 104 to visit. For example, known or suspected inaccuracies; a lack of data; aged or stale data; desire for additional or updated information concerning a particular category (e.g. categories, such as restaurants, which change more frequently than other categories); or other factors can influence the selection of regions or points of interest for a human collector 104 to visit. In particular, in some embodiments, various modules or applications can use data describing such factors to make decisions regarding allocation of human collector 104 time and manpower. In other embodiments, the allocation of human collector 104 resources is performed by an administrative user.

As used herein, a “point of interest” can refer to any feature, landmark, place of interest, or other object or event associated with a geographic location. For instance, a point of interest can include a business, restaurant, retail outlet, coffee shop, bar, music venue, attraction, museum, theme park, arena, stadium, festival, monument, organization, entity, or other suitable points of interest.

Having received an assignment, the human collector 104 can travel through the assigned region or visit each of the listing of points of interest and collect any available information concerning one or more attributes of the visited points of interest. For example, the collecting information can describe attributes of the point of interest such as name, address, phone, category, location, website, business hours, email, etc.

The human collector 104 can input the information into the mobile collection device 102 and the mobile collection device 102 can upload the collected information to the intermediate servers 106. For example, each mobile collection device 102 can communicate with the intermediate servers 106 over a network, such as, for example, a cellular network or other wireless network that permits communication over the Internet. Thus, each mobile collection device 102 can include components for communicating over such a network. The intermediate servers 106 can store the uploaded point of interest information until it is approved for transcription from the intermediate servers 106 to one or more production servers 122.

In some embodiments, rather than manually enter the collected information into the mobile collection device 102 (e.g. through the use of a keypad or virtual keyboard), the human collector 104 can collect the information by capturing a photograph of the point of interest or a photograph that depicts the collected information (e.g. a photograph of a business card or advertisement). Thus, in such embodiments, the mobile collection device 102 can include a camera or can be connectable to an image capture device (e.g. through wireless protocols or a wired connection such as USB) for accessing and uploading captured photographs. The photographs can be uploaded by the mobile collection device 102 to the intermediate servers 106.

In some embodiments, in addition to an indication of its assigned region or listing of desired points of interest, each mobile collection device 102 can be provided with a routing that provides a path for the human collector 104 operating such mobile collection device to traverse through the geographic region. In particular, the path provided by the routing can minimize the distance traveled by the human collector 104 while maximizing the likelihood of the human collector 104 discovering a large number of relevant points of interest.

The routing can be pushed or pulled to the mobile collection devices 102 from the intermediate servers 106. Each routing can be created by the intermediate servers 106 or obtained by the intermediate servers 106 by communicating with a routing device over the network. For example, the routing device can implement a routing module that allows a user to input various parameters (e.g. specification of an assigned region) and, in response to the input, provide the routing. In some embodiments, the routing module can be implemented by a dashboard device 112.

System 100 can also include one or more mobile verification devices 108. Each mobile verification device 108 can be operated by a human verifier 110. Mobile verification devices 108 can be used to perform a quality control process with respect to the information uploaded by the mobile collection devices 102. In particular, the human verifier 110 can visit one or more points of interest for which information was reported by a mobile collection device 102 and provide an indication of an accuracy of such information.

Thus, similar to mobile collection device 102, each mobile verification device 108 can be a computing device that is capable of being transported by a human verifier 110 as the human verifier 110 travels about in the world. For example, mobile verification device 108 can be a mobile computing device such as, for example, a smartphone, tablet, netbook, computing-enabled eyeglasses, computing-enabled watch, wearable computing device, or other portable computing devices.

Each mobile verification device 108 can include various modules or software programs that the device 108 implements to perform desired operations. For example, each mobile verification device 108 can include one or more processors that implement instructions stored in a memory of the device 108 to perform operations and respond to user input.

In an example implementation of system 100, each human verifier 110 or corresponding mobile verification device 108 can be assigned to verify or otherwise visit and report the accuracy of information uploaded by a particular one of the human collectors 104. For example, each human collector 104 can have a worker identifier and such worker identifier can be attached to or otherwise associated with all point of interest information uploaded by the human collector 104. By randomly sampling and verifying the accuracy of such information, the veracity and quality of uploaded information can be monitored and controlled on a collector-by-collector basis.

In some embodiments of the present disclosure, an administrative user 113 can interact with a dashboard device 112 to monitor the state of various processes being performed by the system 100, control work flow, receive statistics regarding productivity, quality control, routes covered by certain human collectors 104, number of listing collected, or collected attributes for certain points of interest.

The dashboard device 112 can be a computing device connected to the intermediate servers 106 and production servers 122 over a network. For example, the dashboard device 112 can be a desktop computer, laptop computer, smartphone, or other computing device. The dashboard device 112 can include one or more processors that implement instructions from a memory. The dashboard device 112 can include locally stored modules that allow the dashboard device 112 to process data received from servers 106 and 112 to provide statistics to the administrative user 113, among other functions. Alternatively, the dashboard device can simply access the dashboard statistical functionality using a browser (e.g. as on-demand software) and the processing of data can occur at the servers 106 and/or 122.

As one example, the administrative user 113 can review the recent quality control data for each human collector 104. In light of such data, the administrative user 113 can select certain human collectors 104 that should be audited or otherwise have their uploaded information verified. Thus, for example, a human collector 104 that has had consistently provided information with a high level of accuracy may only have 10% of her uploaded information verified or may require no verification at all. Likewise, a human collector 104 that has consistently provided information with a low level of accuracy or missed a high number of points of interest in their assigned regions may have 80% or 100% of their uploaded information sent for verification prior to approval.

Thus, in some embodiments, the administrative user 113 can interact with the dashboard device 112 to select certain human collectors 104 for verification. For example, all point of interest information uploaded by the selected collector within a particular range of dates can be selected for verification. The data selected for verification can be assigned to one or more human verifiers 110 or mobile verification devices 108. The selected data can be pushed to the mobile verification devices 108 or the mobile verification devices 108 can request the information from the intermediate servers 106 upon receiving an indication of the human collector 104 that is subject to verification.

To verify the point of interest information received from the mobile collection device 102 and human collector 104, the human verifier 110 can interact with a quality control application implemented by the mobile verification device 108. For example, the mobile verification device 108 can display a map or listing each point of interest verified. When a human verifier 110 selects one of the points of interest, the mobile verification device can display the attribute information uploaded for the selected point of interest. The human verifier 110 can then mark each attribute as incorrect, missing, or unverifiable. In some embodiments, attributes marked as incorrect can be indicated as a major error or a minor error. Furthermore, the mobile verification device 108 can receive input from the human verifier 110 that identifies points of interest that the human collector 104 missed or otherwise failed to upload information concerning. The mobile verification device 108 may also allow for identification of fake listings. For example, the original human collector 104 may have created fake (e.g. non-existent) listings to improve their productivity numbers. The mobile verification device 108 can allow the human verifier 110 to identify these non-real locations and mark them as such.

After visiting each of the points of interest to be verified and providing an indication of each attribute's accuracy, the human verifier 110 can upload a report containing such information from the mobile verification device 108 to the intermediate servers 106.

According to an aspect of the present disclosure, the information provided by the human verifier 110 to the mobile verification device 108 can be used to calculate or otherwise determine the score for the information provided by the human collector 104 over a particular range of dates for which verification is sought. For example, the score can be determined using a scoring formula or scoring matrix.

As an example, the human collector 104 can receive points for correctly reported attributes and lose points for incorrect or missing attributes. In some embodiments, major errors can result in larger reduction in points than minor errors. In some embodiments, the score can be calculated by the mobile verification device 108 at the end of a verification session. Alternatively, the score can be calculated by the intermediate servers 106 and/or the dashboard device 112. Furthermore, in some embodiments, multiple verification reports from multiple human verifiers 110 can be aggregated to provide a single score for a human collector 104.

According to another aspect of the present disclosure, the score calculated for each human collector 104 can be used to determine whether to approve the information uploaded by such human collector 104 or to deny such information and send for re-collection. In some embodiments, the approval or disapproval of each human collector 104 can be automated or otherwise follow a certain logic or algorithm. For example, if the current or average score determined for a given human collector 104 exceeds a threshold value, then the point of interest information provided by such human collector 104 within a recent time period (e.g. day or week) can be automatically approved.

In other embodiments, an administrative user 113 can interact with the dashboard device 112 to view the scores for various human collectors 104 and provide user input indicating whether the information uploaded by each human collector 104 should be approved or denied. Thus, the dashboard device 112 can be used to administratively monitor the quality control process and provide work flow commands.

Once approved, the point of interest information can be provided to a transcription device 114. By interacting with the transcription device 114, a human transcriber 116 can transcribe the uploaded point of interest information into particular data fields. As an example, the human transcriber 116 can inspect and clean up information collected for a given point of interest. For example, typographic errors can be eliminated, shorthand entries can be formalized, and/or duplicate entries can be identified and resolved by the human transcriber 116 through interaction with the transcription device 114.

The transcription device 114 can be a computing device connected to the intermediate servers 106 over a network. For example, the transcription device 114 can be a desktop computer, laptop computer, smartphone, or other computing device. The transcription device 114 can include one or more processors that implement instructions from a memory. The transcription device 114 can include locally stored modules that allow the transcription device 114 to obtain data from the intermediate servers 106 for transcription, among other functions. Alternatively, the transcription device 114 can simply access the transcription functionality using a browser (e.g. as on-demand software) and the processing of data can occur at the servers 106 and/or 122.

In some embodiments, the information uploaded by the human collectors 104 can be photographs or other images that depict the attributes of the point of interest. For example, it may be easier for the human collector 104 to capture (e.g. with the mobile collection device 102) an image of the storefront of a point of interest that displays hours of operation than to physically enter the hours of operation into a text data field. Thus, in such embodiments, the human transcriber 116 can transcribe the textual information contained in the photographs into particular text entry fields corresponding to certain attributes of the point of interest.

In particular, in some embodiments of the present disclosure, one or more optical character recognition techniques can be applied to each image to extract the textual information contained within such image. For example, the optical character recognition techniques can be performed by the mobile collection devices 102, intermediate servers 106, transcription devices 114, or via communication with other computing resources over the network. The extracted textual information can be available for selection within a user interface provided by the transcription device 114. For example, the human transcriber 116 can copy and paste or drag-and-drop the extracted textual information into the particular text entry fields corresponding to certain attributes of the point of interest.

In some embodiments, the character recognition techniques can allow for automatic processing (e.g. transcription) of the textual information included in the images. For example, certain keywords may be used or recognized to automatically extract and associate textual information with one or more particular attributes of the corresponding point of interest listing. Thus, for example, the text “M-F 8-5” can be recognized as communicating information associated with a business hours attribute and can be automatically provided for such attribute without needing to be indicated or transcribed as such by the human transcriber 116.

The transcription stage may also have a quality control process. For example, data describing one or more edits performed by the human transcriber 116 can be provided to a transcription verification device 118. A human transcription verifier 120 can operate the transcription verification device 118 and can indicate an accuracy associated with one or more of the edits. The one or more edits can be approved or denied based at least in part on the indication of accuracy provided by the human transcription verifier 120. As an example, in some embodiments, edits performed by the human transcribers 116 can be approved or denied individually or in batches by the administrative user 113 through interaction with the dashboard device 112.

After transcription, the information can be published on production servers 122 for use by various web services 124. The web services 124 can include, for example, a search engine, a mapping application, on-line advertising services, review platforms, government services, or other online tools. The production servers 122 can provide the point of interest information when requested by various web services 124 using an application programming interface.

Example system 100 can further include one or more mobile maintenance devices 126 respectively operated by human maintenance operators 128. The human maintenance operators 128 can use the mobile maintenance devices 126 to provide verification of existing point of interest information. Thus, similar to mobile collection device 102, each mobile maintenance device 126 can be a computing device that is capable of being transported by a human maintenance operator 128 as the human maintenance operator 128 travels about in the world. For example, each mobile maintenance device 126 can be a mobile computing device such as, for example, a smartphone, tablet, netbook, computing-enabled eyeglasses, computing-enabled watch, wearable computing device, or other portable computing devices.

Each mobile maintenance device 126 can include various modules or software programs that the device 126 implements to perform desired operations. For example, each mobile maintenance device 126 can include one or more processors that implement instructions stored in a memory of the device 126 to perform operations and respond to user input.

In particular, information describing certain points of interest can be selected for re-verification or maintenance. For example, an administrative user 113 can interact with the dashboard device 112 to select particular points of interest or a region of points of interest for re-verification or maintenance. Alternatively, selection of certain points of interest for re-verification can be performed automatically and can be based at least in part on one or more of an age associated with the information associated with each point of interest, a number of user-reported errors, and a value of the location associated with each point of interest.

A listing of the points of interest can be provided to one or more of the mobile maintenance devices 126. For example, the listing can be pushed or pulled to the mobile maintenance device 126 from the production servers 122.

The human maintenance operator 128 can physically visit the selected points of interest and provide an indication of whether the information describing each of such points of interest is verifiable, unverifiable, or inaccurate. For example, the human maintenance operator 128 may provide input to the mobile maintenance device 126 that indicates that certain business listings or other point of interest information is either verified or closed. New listings may also be entered into the maintenance device 126.

The mobile maintenance device 126 can upload the information received from the human maintenance operator 128 to the production servers 122 or other components of system 100. In some embodiments, new point of interest information can be subjected to the quality control process performed by mobile verification devices 108. Business listings that are marked as closed can be removed from the servers 122. In such fashion, previously collected point of interest information can be re-verified over time.

Intermediate servers 106 and production servers 122 can respectively be one or more server computing devices. Each server computing devices can include one or more processors that implement instructions stored in a memory to perform operations. Plural server computing devices can operate according to a sequential computing architecture, a parallel computing architecture, or combinations thereof.

Furthermore, in some embodiments, each of the mobile collection devices 102, mobile verification devices 108, and/or mobile maintenance devices 126 can include a positioning system for determining a current location of such device. The positioning system can be any device or circuitry for analyzing the position of the device. For example, the positioning system can determine actual or relative position by using a satellite navigation positioning system (e.g. a GPS system, a Galileo positioning system, the GLObal Navigation Satellite System (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

In some embodiments, one or more of the mobile collection devices 102, the mobile verification devices 108, the dashboard devices 112, the transcription devices 114, the transcription verification devices 118, and the mobile maintenance devices 126 can be implemented using the same device hardware. For example, each of such devices can be a implemented using a same model, version, or components of a smartphone, tablet, or other computing device. The devices can have different modules or software applications stored thereon to transform the devices into special-purpose computers capable of performing their desired operations.

Thus, the systems and methods of the present disclosure provide a novel pipeline and associated software tools for the collection, processing, and maintenance of point of interest information. The system provides tools for managing work control and data flow, includes multiple instances of quality control, and is highly scalable. In particular, the system allows for various assignments and associated data to be passed back and forth over one or more networks (e.g. “through the cloud”). Furthermore, features such as optimized routing for street-level data collection and optical character recognition for transcription of textual information from collected images enhance the speed and efficiency of data collection and processing.

### Example Mobile Collection Device

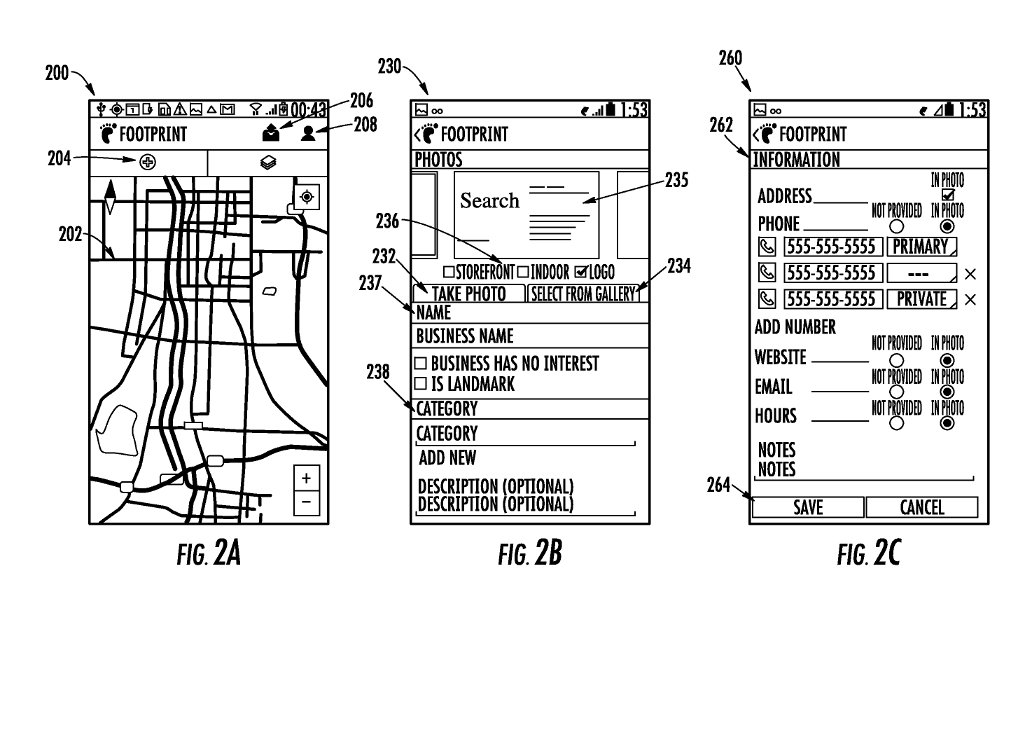

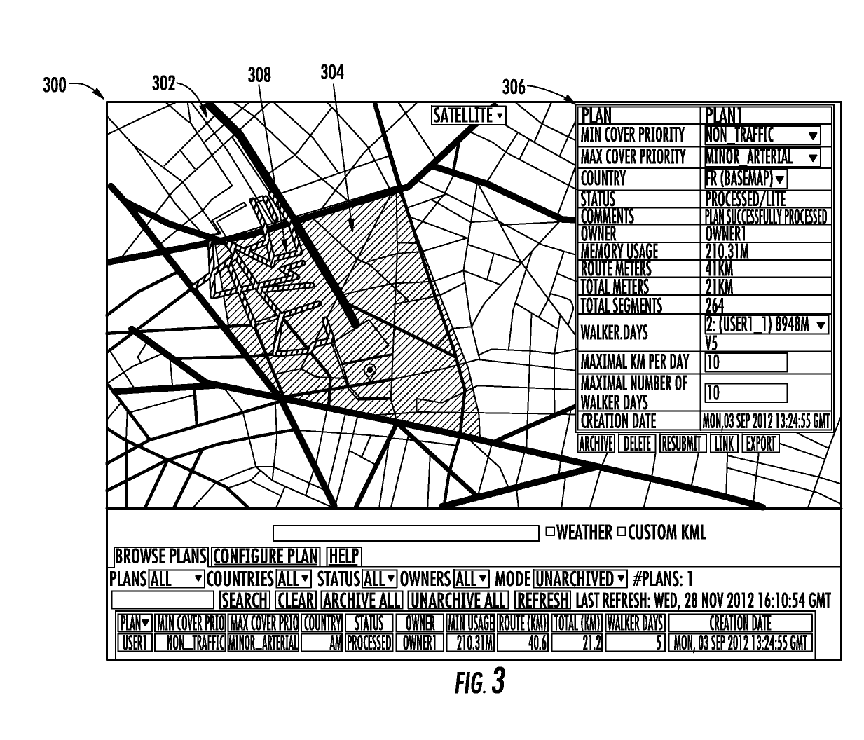

FIGS. 2A-2C depict example mobile collection device user interfaces 200, 230, and 260 according to an example embodiment of the present disclosure.

User interface 200 depicts the mobile collection device in a map mode in which the user is provided with a map 202. The user's current location may be indicated on the map 202. In addition, an assigned region for which the user is expected to collect point of interest information can be overlaid upon the map 202.

By selecting the new point of interest button 204, the user can create a new point of interest entry. The user can provide the location of the newly created point of interest by placing a marker on the map 202. Alternatively, the location of the newly created point of interest can automatically snap to the current location of the user (e.g. as determined by a GPS system or other positioning system included in the mobile collection device).

Referring now to FIG. 2B, the user can input information concerning attributes of the newly created point of interest via user interface 230. For example, the user can capture a new photograph of the point of interest or a photograph depicting attributes of the point of interest by selecting button 232. The user can also access photographs stored in memory and associate one of such photographs with the point of interest by selecting button 234.

The captured or selected photograph can be displayed in a photograph section 235 of the user interface 230. The currently highlighted (e.g. centered) photograph in section 235 can be marked as a storefront photograph, an indoor photograph, or a logo photograph by selection of one or more of the boxes 236.

The system can receive from a user the name of the point of interest and other information into the name section 237 of the user interface 230. The user can input one or more categories to which the point of interest belongs into category section 238. In some embodiments, the categories can be selected from a drop down menu or other tool.

Referring now to FIG. 2C, the user interface 260 depicts a continuation of information collection and entry for the new point of interest. In particular, various attributes such as address, phone, website, email, business hours, or other notes can be entered into various entry fields in the information section 262 of the user interface 260. As shown in FIG. 2C, the user can mark certain attributes as being depicted within one of the associated photographs.

After the user has completed the various sections, the user can select the save button 264 to store the entered information and create the new point of interest. The saved information can be transmitted to a central server at that time or can be stored for batch transmission at the completion of a collection session. The user may also cancel the entry. After saving or cancelling the entered information, the mobile collection device may return to map mode.

Referring again to FIG. 2A, the user can upload all currently entered information by selecting button 206. The user may also select or switch between worker identifiers by selecting button 208. Further, in some embodiments, a particular routing for the user to follow may be overlaid upon map 202.

FIG. 3 depicts an example route planning user interface 300 according to an example embodiment of the present disclosure. In particular, in some embodiments of the present disclosure, user interface 300 may be accessed by implementing a routing module or routing application on a dashboard device. Alternatively, the routing application can be accessed by the dashboard device via a browser (e.g. as on-demand software) and the processing of data (e.g. routing functionality) can occur fully or partially at one or more remote computing resources accessed over a network.

Route planning user interface 300 can provide a map 302 of an area, such as, for example, a city. In some embodiments, the user can interact with the map 302 to define a region 304 that will be assigned to a particular human collector. For example, the user can draw or otherwise mark the boundaries of region 304 on the map. Alternatively, the regions may be pre-defined according to various criteria and selected from via user interface 300.

The user interface 300 can also provide a settings box or window 306 that allows the user to modify various settings or parameters that will influence a resulting routing. For example, as shown in FIG. 3, the settings window 306 can allow a user to indicate a minimum coverage priority (e.g. non-traffic roadways) and a maximum coverage priority (e.g. minor arterial roadways). Other parameters can be adjusted as well.

The routing module or application can determine a routing 308 based at least in part on the region 304 and the parameters entered into window 306. As an example, the routing 308 can specify a path that minimizes the distance traveled by the human collector while maximizing the likelihood of the human collector discovering a large number of relevant points of interest. In particular, the path can maximize the likelihood of the human collector discovering points of interest included in the region 304 that satisfy the parameters entered into window 306.

The routing 308 can be pushed or pulled to a mobile collection device associated with a human collector that is assigned to collect point of interest information contained within region 304. For example, multiple routings for different regions or parameters can be generated and stored (e.g. at the intermediate servers). A particular routing can then be pushed or pulled from the server to a mobile collection device when a particular region or set of points of interest are assigned to a human collector.

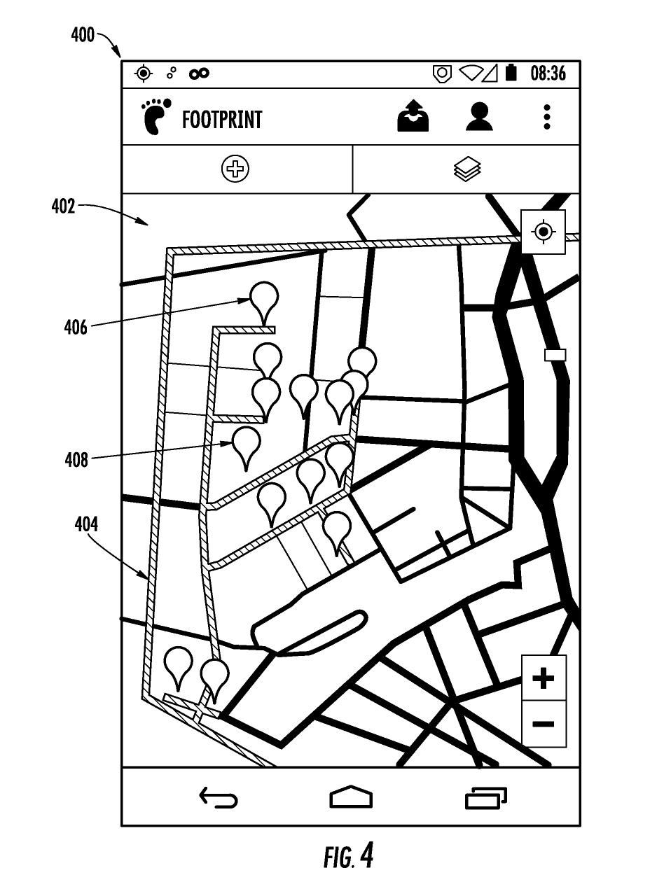

FIG. 4 depicts an example mobile collection device user interface 400 according to an example embodiment of the present disclosure. In particular, the mobile collection device is operating in the map mode, whereby a map 402 is provided in the user interface 400. A routing 404 is overlaid upon the map 402. The routing can provide a path for the user of the mobile collection device to follow to visit various points of interest (e.g. as indicated by markers 406 and 408) while travelling a minimized distance.

### Example Mobile Verification Device

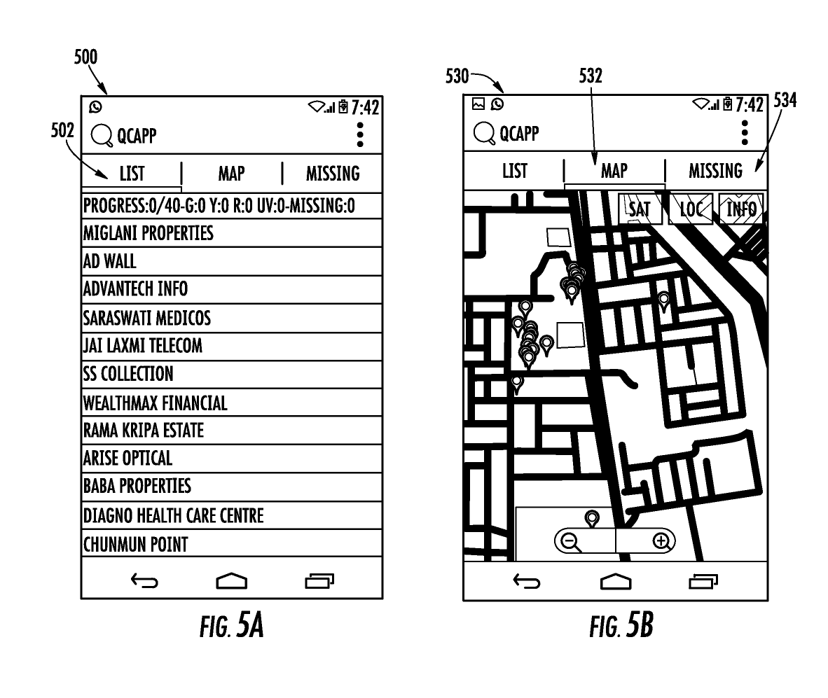

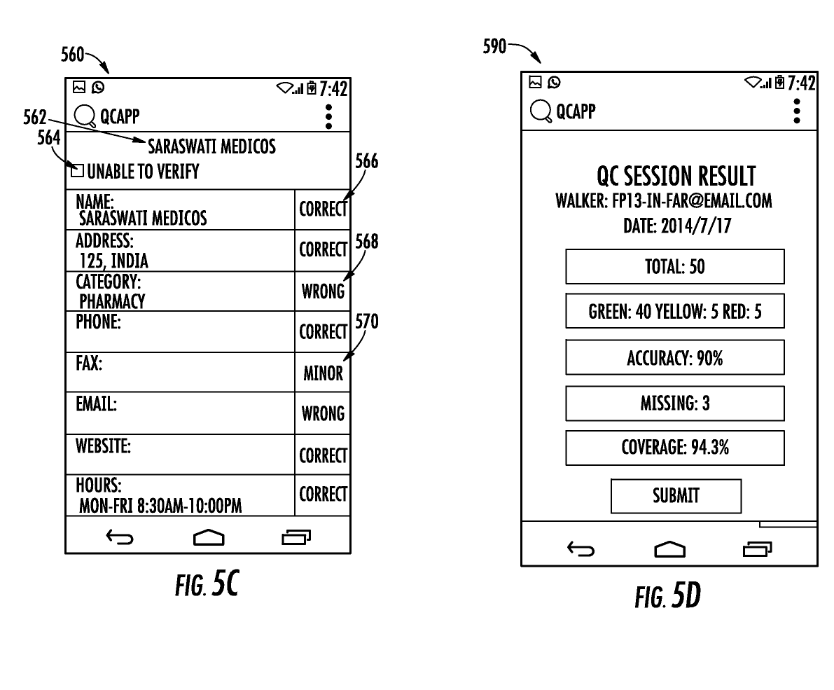

FIGS. 5A-5D depict example mobile verification device user interfaces 500, 530, 560, and 590 according to an example embodiment of the present disclosure.

Referring to FIG. 5A, user interface 500 depicts the mobile verification device in a list mode in which a list of points of interest that the user is expected to verify is provided. For example, the points of interest can be listed in the sequence in which they were collected. The user can select one of the points of interest from the list to receive an interface (e.g. interface 560 of FIG. 5C) for providing indications of accuracy of the information collected for such point of interest. The device can be placed into list mode by selecting button 502. Search functionality can also be provided so that the user can search for a particular point of interest.

In particular, in some embodiments an administrative user can select a batch of point of interest information to be verified (e.g. all information uploaded by a given walker over a certain period of time). The batch of point of interest information can then be pushed to a mobile verification device for verification. In other embodiments, the user of the mobile verification device may interact with a user interface of the mobile verification device to input various parameters such as a human collector identifier, a range of dates, and/or a particular region. All information uploads that satisfy the input criteria can then be pulled from the intermediate server to the mobile verification device.

Referring now to FIG. 5B, user interface 530 depicts the mobile verification device in a map mode. In map mode, a plurality of markers are provided at locations on a map that correspond to locations at which the points of interest that the user is expected to verify are located. The user's current location may also be shown on the map. The user can select one of the markers to receive an interface (e.g. interface 560 of FIG. 5C) for providing indications of accuracy of the information collected for such point of interest. The device can be placed in map mode by selecting button 532.

Furthermore, if the user of the mobile verification device discovers a point of interest for which information was not collected by the human collector, the user can select button 534 to report a missing point of interest. Selection of button 534 can result in the user being provided with an interface to enter information concerning the missing point of interest. For example, such interface may be similar to interfaces 230 and 260 of FIGS. 2B and 2C. In other embodiments, however, entry of a missing point of interest consists of only a title and a rough location. In such embodiments, the missing entry will be stored for quality control statistical purposes only, and will not create a new point of interest entry at the intermediate servers. Instead, for example, a human collector may be dispatched to the rough location to collect information regarding the missing point of interest. In some embodiments, the mobile verification device may also allow for identification of fake listings. For example, the original human collector may have created fake (e.g. non-existent) listings to improve their productivity numbers. The mobile verification device can provide tools for the human verifier to identify these non-real locations and mark them as such.

Referring now to FIG. 5C, user interface 560 provides tools for the user of the mobile verification device to provide an indication of the accuracy of various attributes collected for a particular point of interest 562. For example, if the user is unable to verify the existence of the point of interest 562 altogether, then the user may indicate this by selecting box 564. However, if the point of interest 562 is able to verified, then the accuracy of the collected attribute information can be indicated on an attribute-by-attribute basis.

For example, the name attribute has been marked as correct at 566. As another example, the category attribute has been marked as wrong at 568. As another example, the fax attribute has been indicated as including a minor error at 570. Attributes may also be indicated as unverifiable or missing.

Thus, the user of the mobile verification device can provide an indication of the accuracy for each attribute for each point of interest assigned to the user. Upon completion of the verification process for all points of interest, the user can end the verification session.

Referring now to FIG. 5D, user interface 590 depicts a summary of the verification session. For example, the summary can include an identifier for the human collector and/or the human verifier; a total number of points of interest and/or attributes for which an indication of accuracy was provided; a summary of the indications of accuracy; an accuracy score; a number of missing points of interest identified by the human verifier; and a coverage score. For example, the accuracy score can be based on the indications of accuracy while the coverage score can be based on the number of verified points of interest versus the number of missing points of interest.

The user can select a submit button to upload the report and all associated data to a central authority, such as, for example, the intermediate servers. In some embodiments, the human verifier is not required to verify each point of interest downloaded to the mobile verification device. In such embodiments, the score and/or session summary can be determined based on only the points of interest for which some verification was received. However, in some embodiments, a defined minimum number of points of interest must be verified to render a valid verification session.

In such fashion, the mobile verification device and its associated software can be used to provide a quality control process for information uploaded by human collectors. In particular, the information input into the mobile collection device (e.g. indications of accuracy and/or identification of missing points of interest) can be used to determine a score for a human collector that initially uploaded the information for the points of interest.

As one example, in some embodiments, each point of interest listing can begin with a full score of ten points. For each attribute of the point of interest, if there is an incorrect data entry or the attribute is missing, then points can be subtracted. Each listing can have a final result score. Listings can be categorized (e.g. “green,” “yellow,” or “red”) based on the final result score. The verification session summary can provide a summary of the number of points of interest in each category and what percentage of the whole each category commands.

The score can be used to determine whether to approve batches of information uploads for transcription of whether to deny the batches of information uploads and send for re-collection. A pending/wait option can also be applied to the batches of information uploads. For example, an administrative user can interact with a dashboard device to receive summaries of recent verification sessions for a particular human collector (e.g. in the form of a chart graph or other interactive statistical features). Decisions regarding work flow and data approval can be made based on such statistics.

### Example Transcription Device

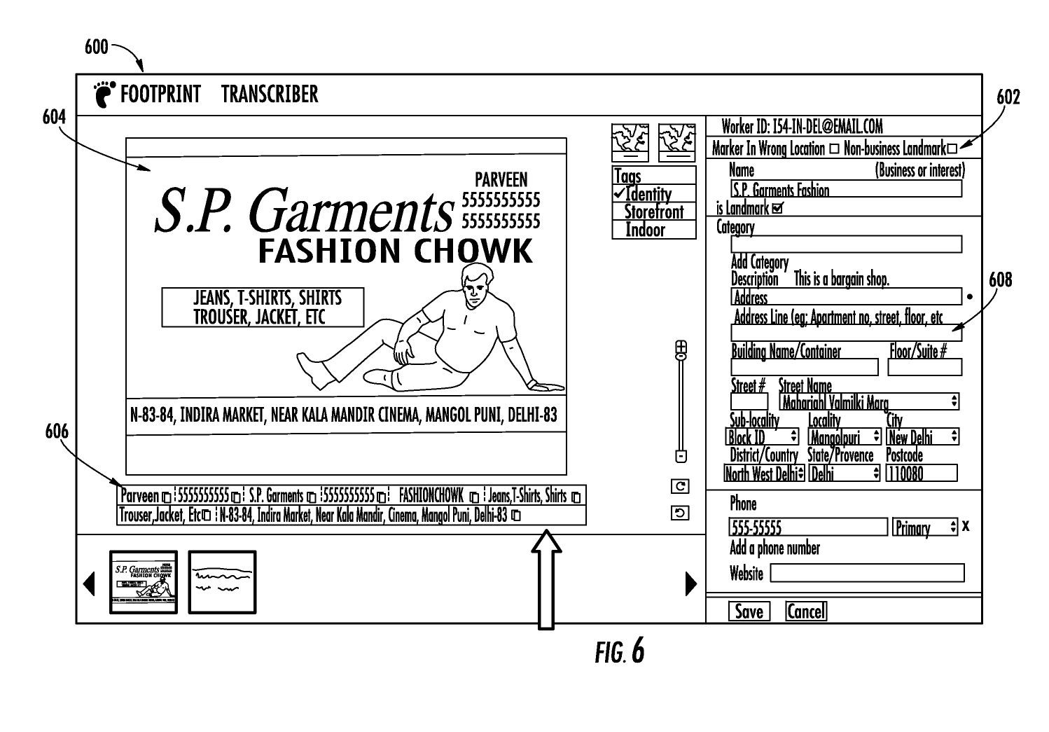

FIG. 6 depicts an example transcription device user interface 600 according to an example embodiment of the present disclosure. User interface 600 can include a transcription section 602 that includes a plurality of data entry fields in which a user can enter and/or edit textual information. For example, the data entry fields can correspond to a plurality of attributes for a point of interest being transcribed by the user. Thus, the user can interact with the user interface 600 to transcribe information associated with the point of interest (edit, formalize, segment, or supplement the point of interest information).

The points of interest assigned to a user for transcription can be determined according to similar methods discussed above with respect to human collectors and human verifier's. For example, an assignment tool can be used to assign tasks to a human transcriber based upon certain criteria such as, for example, geographical region, address, human collector, or other criteria. The assignments can be automatic or can be defined based on user input from an administrative user.

User interface 600 can also include an image section that displays one or more images 604. In particular, the image 604 can be an image that was collected and uploaded by a human collector. The user of the transcription device can visually retrieve information from the image 604 and enter it into the transcription section 602.

Furthermore, in some embodiments of the present disclosure, one or more optical character recognition algorithms can be applied to the image 604 to extract the textual information from the image. The textual information extracted from image can be provided for selection in user interface 600. As an example, as shown in FIG. 6, section 606 of user interface 600 can include a plurality of textual strings extracted from the image 604.

The user can select an icon adjacent to each textual string to copy such textual string. The user can then paste the copied textual string into one of the data entry fields of transcription section 602. Alternatively, the user can drag and drop one of the textual strings into one of the data entry fields. For example, the address string contained in section 606 can be dragged and dropped into data entry field 608, which corresponds to an address attribute of the point of interest. In such fashion, textual information contained within photographs captured by human collectors can quickly and easily be transcribed without requiring manual data entry.

In some embodiments, the character recognition techniques can allow for automatic processing (e.g. transcription) of the textual information included in the images. For example, certain keywords may be used or recognized to automatically extract and associate textual information with one or more particular attributes of the corresponding point of interest listing. Thus, for example, the text “M-F 8-5” can be recognized as communicating information associated with a business hours attribute and can be automatically provided or inserted into the data entry field for such attribute without needing to be indicated or transcribed as such by the human transcriber.

Once the appropriate data entry fields of the transcription section 602 have been completed, the user may save the entered information or edits. The transcribed information can then be published into one or more production servers for access by one or more web services (e.g. via an application programming interface). In some embodiments, however, the transcribed information must pass a quality control process prior to publication.

Furthermore, in some embodiments of the present disclosure, duplication detection and resolution can be performed at the transcription stage. For example, when a transcriber finishes transcription of a listing, the listing can be created and then subjected to duplicate detection. Duplicate detection can be performed based on attribute matching including, for example, name matching and/or address matching. The user can be presented with a listing of potential duplicates and can indicate whether one or more of such potential duplicates are, in fact, duplicative of the recently transcribed listing. Duplicate entries can be merged. In some embodiments, the human transcriber may be permitted to purge one, but not more than one, duplicates into a single entry. If no duplicates are found or indicated, the listing can be published to the server or otherwise rendered active.

In some embodiments, duplicate entries can be automatically merged according to one or more defined emerging rules. For example, certain attributes may be considered as ineligible for overwriting or eligible for overwriting. As another example, multi-value attributes (e.g. categories or phone numbers) may be merged by taking the union of all available attribute information. For many attributes, however, the default rule can be to overwrite existing attribute information with new information provided by the most recent transcription. However, if the most recent transcription does not provide new data for an attribute, then any existing attribute information may be kept for such attribute.

### Example Mobile Maintenance Device

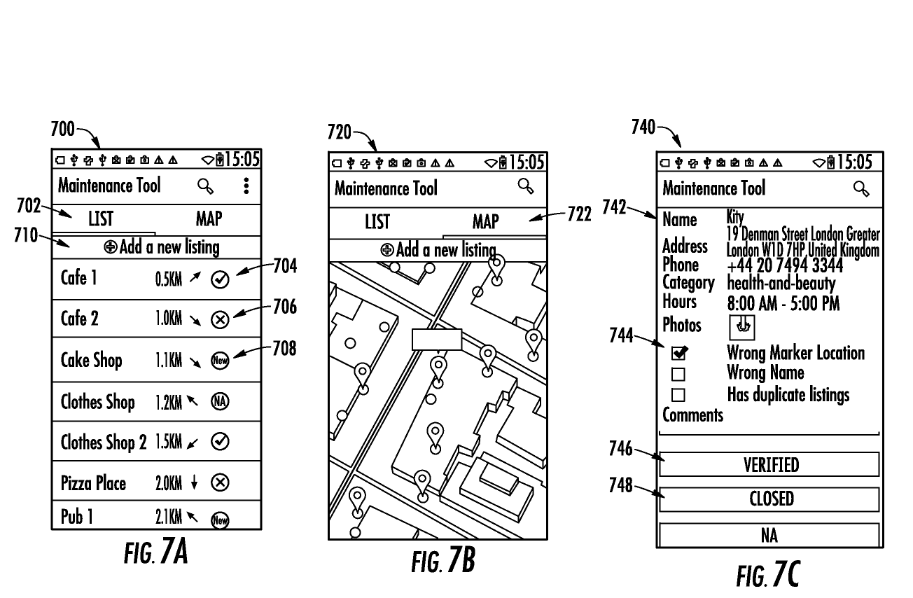

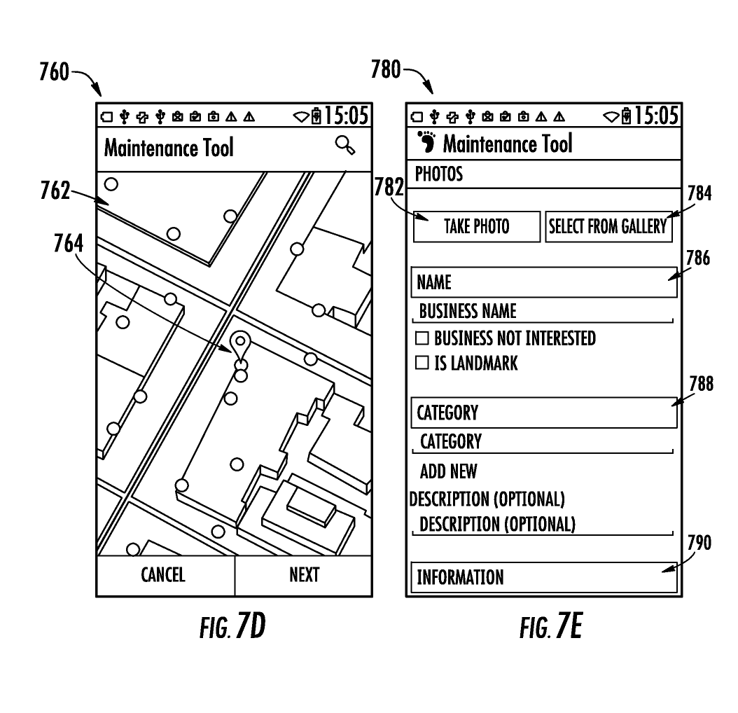

FIGS. 7A-7E depict example mobile maintenance device user interfaces 700, 720, 740, 760, and 780 according to an example embodiment of the present disclosure.

Referring to FIG. 7A, user interface 700 depicts the mobile maintenance device in a list mode in which a list of points of interest that the user is expected to re-verify or maintain. The user can select one of the points of interest from the list to receive an interface (e.g. interface 740 of FIG. 7C) for providing re-verification of point of interest information. The device can be placed into list mode by selecting button 702. Search functionality can also be provided so that the user can search for a particular point of interest.

An icon can be provided next to each point of interest in the list. For example, icon 704 is a check mark that indicates that the corresponding point of interest has been verified by the user. Icon 706 is an X mark that indicates that the corresponding point of interest has been indicated as closed (e.g. no longer in existence) by the user. Icon 708 includes the word “new” and indicates that the corresponding point of interest has been newly added by the user. An “NA” icon can indicate that the corresponding point of interest was unable to be either verified or confirmed as closed.

In some embodiments an administrative user can select certain point of interest information to be re-verified. Alternatively, certain points of interest may be automatically selected for re-verification when they meet certain criteria. Selections of points of interest for re-verification can be based on one or more of an age associated with the information associated with each point of interest, a number of user-reported errors for each point of interest, and a value of a location associated with each point of interest. For example, points of interest along high-traffic (e.g. road traffic, foot-traffic, shopping volume, etc.) may be subject to more frequent re-verification.

The selected points of interest can be pushed to a mobile maintenance device for verification. In other embodiments, the user of the mobile maintenance device may interact with a user interface of the mobile maintenance device to input various parameters (e.g. a particular region). All points of interest that satisfy the input criteria can then be pulled from the production servers to the mobile maintenance device. In some embodiments, each mobile maintenance device can download multiple maintenance session plans and switch between such plans. In some embodiments, plans can be merged.

If the user of the mobile maintenance device discovers a point of interest for which information apparently has never been collected, the user can select button 710 to report a new point of interest. Selection of button 710 can result in the user being provided with an interface to enter information concerning the new point of interest, as will be discussed with reference to FIGS. 7D and 7E.

Referring now to FIG. 7B, user interface 720 depicts the mobile maintenance device in a map mode. In map mode, a plurality of markers are provided at locations on a map that correspond to locations at which the points of interest that the user is expected to re-verify are located. The user's current location may also be shown on the map. The user can select one of the markers to receive an interface (e.g. interface 740 of FIG. 7C) for providing re-verification of point of interest information. The device can be placed in map mode by selecting button 722.

In addition, in some embodiments, routings for the mobile maintenance operators to follow can be provided to the mobile maintenance device along with identification of the points of interest to re-verify. The routing can provide a path among the plurality of points of interest. In some embodiments, the markers can be displayed using different colors or patterns to indicate the current status of the re-verification of the corresponding point of interest (e.g. verified, closed, etc.).

Referring now to FIG. 7C, user interface 740 provides tools for the user of the mobile maintenance device to re-verify previously collected point of interest information. For example, in section 742 user interface 740 the attribute information for the point of interest can be listed. The user can indicate a wrong marker location (e.g. address), a wrong name, or the existence of duplicate listings, through selection of one or more of boxes 744. Further, a data entry field may be used to provide additional comments.

Generally, however, the user of the maintenance device can re-verify the point of interest information as a whole by selecting the verified button 746. Likewise, user of the maintenance device can indicate that the point of interest is closed were no longer in existence by selecting button 748. A not-available (“NA”) button can be provided to mark a point of interest that is unable to be located or verified, but cannot be confirmed as closed.

Referring now to FIG. 7D, user interface 760 allows a user to select and location associated with a new point of interest being entered by the user. For example, user may place and marker 764 on a map 762 at the location at which the point of interest is located. The user can actively place marker 764 on the map 762. Alternatively, the location of the newly created point of interest can automatically snap to the current location of the user (e.g. as determined by a GPS system or other positioning system included in the mobile collection device).

Referring now to FIG. 7E, the user can input information concerning attributes of the newly created point of interest via user interface 780. For example, the user can capture a new photograph of the point of interest or a photograph depicting attributes of the point of interest by selecting button 782. The user can also access photographs stored in memory and associate one of such photographs with the point of interest by selecting button 784.

The user can input the name of the point of interest and other information into the name section 786 of the user interface 780. The user can input one or more categories to which the point of interest belongs into category section 788. In some embodiments, the categories can be selected from a drop down menu or other tool.

The user can also input various attributes such as address, phone, website, email, business hours, or other notes can be entered into various entry fields in the information section 790 of the user interface 780.

After the user has completed the various sections, the user can select a save button to store the entered information and create the new point of interest. The saved information can be transmitted to a central server at that time or can be stored for batch transmission at the completion of a maintenance session. The user may also cancel the entry. After saving or cancelling the entered information, the mobile collection device may return to map mode or list mode.

In some embodiments, the newly created point of interest and associated attribute information can be automatically published into the production servers. In other embodiments, the newly created point of interest and associated attribute information can be placed into the intermediate servers and subject to quality control as if it was uploaded by a human collector using a mobile collection device. In yet further embodiments, the new entry will not create a new point of interest entry at either the intermediate servers or the production servers. Instead, for example, a human collector may be dispatched to the location to collect information regarding the new point of interest.

### Additional Description

Certain embodiments are described in this disclosure as including logic or a number of components, modules, or mechanisms. Modules can constitute either software modules (e.g., code embodied on a machine-readable medium or in a transmission signal) or hardware modules. A hardware module is tangible unit capable of performing certain operations and can be configured or arranged in a certain manner. In example embodiments, one or more computer systems (e.g., a standalone, client or server computer system) or one or more hardware modules of a computer system (e.g., a processor or a group of processors) can be configured by software (e.g., an application or application portion) as a hardware module that operates to perform certain operations as described in this disclosure.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel. Distributed systems may be located in one or more physical locations.

While the present subject matter has been described in detail with respect to specific example embodiments and methods thereof, those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent to one of ordinary skill in the art.

What is claimed is:

1. A computer-implemented method for information collection and verification, the method comprising:
receiving, by one or more computing devices from each of a plurality of mobile collection devices, a plurality of information uploads respectively describing one or more attributes for a plurality of points of interest, wherein the plurality of mobile collection devices are respectively operated by a plurality of human collectors;
providing, by the one or more computing devices to a mobile verification device, the plurality of information uploads associated with a first human collector of the plurality of human collectors, wherein the mobile verification device is operated by a human verifier;
receiving, by the one or more computing devices from the mobile verification device, data indicative of an accuracy associated with one or more of the plurality of information uploads associated with the first human collector; and
determining, by the one or more computing devices or the mobile verification device, a score for the first human collector based at least in part on the data indicative of the accuracy associated with the one or more of the plurality of information uploads associated with the first human collector;
wherein the score determined for the first human collector is used at least in part to determine whether to approve the plurality of information uploads associated with the first human collector.

2. The computer-implemented method of claim 1, further comprising:
providing, by the one or more computing devices to a transcription device, one or more of the plurality of information uploads that have been approved;
receiving, by the one or more computing devices from the transcription device, one or more edits to one or more of the attributes described by one or more of the plurality of information uploads that have been approved.

3. The computer-implemented method of claim 2, further comprising:
providing, by the one or more computing devices to a transcription verification device, data describing the one or more edits received by the transcription device;
receiving, by the one or more computing devices from the transcription verification device, data indicative of an accuracy associated with one or more of the edits; and
determining, by the one or more computing devices, whether the approve the one or more edits based at least in part on the data indicative of the accuracy associated with the one or more of the edits.

4. The computer-implemented method of claim 1, further comprising, when it is determined to approve the plurality of information uploads associated with the first human collector, publishing, by the one or more computing devices, the one or more attributes for the plurality of points of interest for access by one or more web services.

5. The computer-implemented method of claim 4, further comprising:
selecting, by the one or more computing devices, one or more of the plurality of points of interest for which the one or more attributes have been published;
providing, by the one or more computing devices to mobile maintenance devices, data identifying the selected one or more of the plurality of points of interest;
receiving, by the one or more computing devices from the mobile maintenance devices, data indicating that one or more of the attributes have been verified as still correct.

6. The computer-implemented method of claim 5, wherein selecting, by the one or more computing devices, one or more of the plurality of points of interest for which the one or more attributes have been published comprises selecting, by the one or more computing devices, the one or more of the plurality of points of interest based at least in part on one or more of an age associated with the information upload associated with each point of interest, a number of user-reported errors, and a value of a location associated with each point of interest.

7. The computer-implemented method of claim 1, wherein each of the plurality of information uploads respectively describing the one or more attributes for the plurality of points of interest comprises one or more photographs depicting information associated one of the plurality of points of interest.

8. The computer-implemented method of claim 7, further comprising:
providing, by the one or more computing devices to a transcription device, one or more of the plurality of information uploads that have been approved;
wherein optical character recognition is performed with respect to the one or more photographs to identify textual information contained within the one or more photographs; and
wherein the identified textual information is provided for selection within a user interface provided by the transcription device.

9. The computer-implemented method of claim 1, further comprising, prior to receiving, by one or more computing devices from each of the plurality of mobile collection devices, the plurality of information uploads respectively describing one or more attributes for the plurality of points of interest:
assigning, by the one or more computing devices, a geographic region to each of the plurality of human collectors;
providing, by the one or more computing devices to each of the plurality of mobile collection devices, a routing that provides a path for the human collector operating such mobile collection device to traverse through the geographic region.

10. The computer-implemented method of claim 1, further comprising:
receiving, by the one or more computing devices from the mobile verification device, data indicating that the first human collector failed to provide an information upload for one or more points of interest located within a region that was assigned to the first human collector;
wherein the score for the first human collector is determined based at least in part on the data indicating that the first human collector failed to provide the information upload for the one or more points of interest.

11. One or more non-transitory computer-readable media storing instructions that, when executed by one or more computing devices, cause the one or more computing devices to perform operations comprising:
receiving, from a mobile collection device operated by a human collector, data describing one or more attributes for each of a plurality of points of interest;
providing, to a mobile verification device operated by a human verifier, the data describing the one or more attributes for each of the plurality of points of interest;
receiving, from the mobile verification device, an indication of an accuracy associated with the one or more attributes for one or more of the plurality of points of interest, wherein it is determined whether the data received from the mobile collection device describing the one or more attributes for each of the plurality of points of interest should be approved based at least in part on the indication of the accuracy received from the mobile verification device;
when the data received from the mobile collection device is approved, providing, to a transcription device, the data describing the one or more attributes for each of the plurality of points of interest; and
receiving, from the transcription device, updated data describing the one or more attributes for each of the plurality of points of interest, wherein the updated data includes one or more edits.

12. The one or more non-transitory computer-readable media of claim 11, wherein the operations further comprise:
providing, to a transcription verification device, the updated data, wherein the one or more edits are presented in a user interface of the transcription verification device; and
receiving, from the transcription verification device, an indication of an accuracy of the one or more edits, wherein it is determined whether the updated data should be published based at least in part on the indication of the accuracy received from the transcription verification device.

13. The one or more non-transitory computer-readable media of claim 11, wherein the operations further comprise:
providing, to a mobile maintenance device, the published data describing the one or more attributes for each of the plurality of points of interest; and
receiving, from the mobile maintenance device, an indication, for one or more of the plurality of points of interest, of whether the published data is still accurate.

14. The one or more non-transitory computer-readable media of claim 11, wherein providing, to the mobile verification device operated by the human verifier, the data describing the one or more attributes for each of the plurality of points of interest comprises:
providing, to the mobile verification device, a routing between the plurality of points of interest, wherein the human verifier travels along the routing when verifying the data describing the one or more attributes for each of the plurality of points of interest.

15. The one or more non-transitory computer-readable media of claim 11, wherein the indication of the accuracy received from the mobile verification device comprises, for each of the plurality of points of interest, an indication of whether each of the one or more attributes for such point of interest is correct, incorrect, unverifiable, or missing.

16. A system for collecting information, the system comprising:
a plurality of mobile collection devices respectively operated by a plurality of human collectors, wherein each of the mobile collection devices uploads to one or more intermediate servers information describing one or more attributes of a plurality of points of interest;
a mobile verification device, wherein the mobile verification device receives, from the one or more intermediate servers, information uploaded by a first mobile collection device of the plurality of mobile collection devices and provides an indication of an accuracy associated with the information received from the first mobile collection device, and wherein a score is calculated for the human collector of the first mobile collection device based at least in part on the indication of the accuracy provided by the mobile verification device, the score being used to assist in a determination of whether to approve the information uploaded by the first mobile collection device for transcription;
the one or more intermediate servers; and
one or more production servers, wherein the information uploaded by the first mobile collection device is transcribed from the one or more intermediate servers to the one or more production servers when the information is approved for transcription.

17. The system of claim 16, further comprising:
a transcription device, wherein the transcription device:
receives the information uploaded by the first mobile collection device;
displays the information to a human transcriber; and
receives one or more edits inputted by the human transcriber; and
a transcription verification device, wherein the transcription verification device:
displays the one or more edits to a user; and
receives user input indicating an accuracy of the one or more edits;
wherein it is determined whether to approve the one or more edits based at least in part on the user input; and
wherein, when the one or more edits are approved, the information uploaded by the first mobile collection device, as edited by the one or more edits, is moved from the one or more intermediate servers to the one or more production servers for publication to one or more web services.

18. The system of claim 17, wherein:
the information uploaded by the first mobile collection device comprises one or more photographs of one or more of the plurality of points of interest;
an optical character recognition technique is applied to the one or more photographs to identify textual content included in the photographs; and
the one or more edits inputted by the human transcriber comprise a matching of certain of the textual content to a first attribute of the one or more attributes.

19. The system of claim 17, further comprising:
a mobile maintenance device, wherein the mobile maintenance device:
receives, from the one or more production servers, the information describing the one or more attributes of the plurality of points of interest; and
receives, from a human maintenance operator, an indication of whether the information describing the one or more attributes of the plurality of points of interest is verifiable, unverifiable, or inaccurate.

20. The system of claim 16, further comprising:
a dashboard device, wherein the dashboard device:
receives the score calculated for the human collector of the first mobile collection device;
displays the score to an administrative user; and
receives a user input from the administrative user, the user input indicating whether the information uploaded by the first mobile collection device is approved for transcription or is denied and should be sent for re-collection.
